(19) United States
(12) Patent Application Publication
(10) Pub. No.: US 2011/0093840 A1
(43) Pub. Date: Apr. 21, 2011

(54) PATCHES FOR BATTERY-INTERFACING DEVICES AND ASSOCIATED SYSTEMS AND METHODS

(75) Inventors: Rory A. J. Pynenburg, Ridgefield, WA (US); William A. Planck, Beaverton, OR (US); Claudiu Bulai, Redmond, WA (US)

(73) Assignee: Micro Power Electronics, Inc., Beaverton, OR (US)

(21) Appl. No.: 12/909,415

(22) Filed: Oct. 21, 2010

Related U.S. Application Data
(60) Provisional application No. 61/253,830, filed on Oct. 21, 2009.

(51) Int. Cl. G06F 9/44; H02J 7/00

(52) U.S. Cl. 717/168; 320/107

(57) ABSTRACT

Patches for battery-interfacing devices and associated systems and methods are disclosed. A patch device in accordance with one embodiment includes a storage medium having a patch, the patch including information that is not specific to only the patch device. The patch device can further include a data terminal coupled to the storage medium and coupleable to a corresponding data terminal of a battery port of a host device. The patch is transmissible away from the storage medium via the data terminal. A method in accordance with a particular embodiment includes powering a host device by connecting a battery pack to the host device via a power terminal and a data terminal of the battery pack and corresponding power terminal and data terminal of the host device. Information is conveyed to the host device via the data terminal of the battery pack that is specific to just the battery pack. The battery pack is then removed from the host device and a patch device is connected to the host device via a data terminal of the patch device and the corresponding data terminal of the host device. The method further includes transmitting a patch from a storage medium of the patch device to the host device via the data terminal of the patch device and the data terminal of the host device, with the patch including information that is not specific to just the patch device.

### CROSS-REFERENCE TO RELATED APPLICATION

The present application claims priority to pending U.S. Provisional Application No. 61/253,830, filed Oct. 21, 2010 and incorporated herein by reference. To the extent that the foregoing provisional application and/or any other materials incorporated herein by reference conflict with the present application, the present application controls.

### TECHNICAL FIELD

The present disclosure is related to methods of patching or otherwise updating battery-interfacing devices, such as battery chargers.

### BACKGROUND

Many portable electronic devices employ a battery package in lieu of conventional batteries or conventional battery arrangements. Existing battery packages are rechargeable and customizable, and typically include an array of rechargeable battery cells, circuitry for monitoring and regulating output power, and a casing that houses the battery cells and battery circuitry. Accordingly, battery packages can be tailored so that the battery cells meet specific power requirements, the package circuitry provides power feedback and control, and the package casing protects the package cells and circuitry from various environmental factors. For example, battery cells for portable medical equipment (e.g., defibrillators, portable X-ray devices, and insulin pumps) are designed to meet stringent power tolerances. The package circuitries for hand-held data collection devices (e.g., barcode scanners, RFID readers, and portable printers) are configured to accommodate usage patterns, and the package casings for field instruments have contact openings that are fitted with Gortex® seals to prevent moisture from entering the battery package.

Battery packages are typically recharged with a suitable charger. A battery charger typically includes information, such as firmware, software and/or data, which enables the battery charger to perform various charging (and in some case, discharging) and/or other functions. It can be desirable in some circumstances to modify such information. However, this is a time-consuming and labor intensive effort in light of the number of chargers that may be deployed. Accordingly, there remains a need in the industry for improved chargers and associated update methodologies.

### BRIEF DESCRIPTION OF THE DRAWINGS

FIG. 1 is an isometric view of a system, including a battery package and a battery charger, configured in accordance with an embodiment of the disclosure.

FIG. 2 is a block diagram illustrating components of the system of FIG. 1.

FIG. 3 is a flow diagram of a process for patching a battery charger in accordance with an embodiment of the disclosure.

FIG. 4 is a flow diagram of a process for patching a battery charger in accordance with another embodiment of the disclosure.

FIG. 5 is an isometric view of various devices configured in accordance with embodiments of the disclosure.

### DETAILED DESCRIPTION

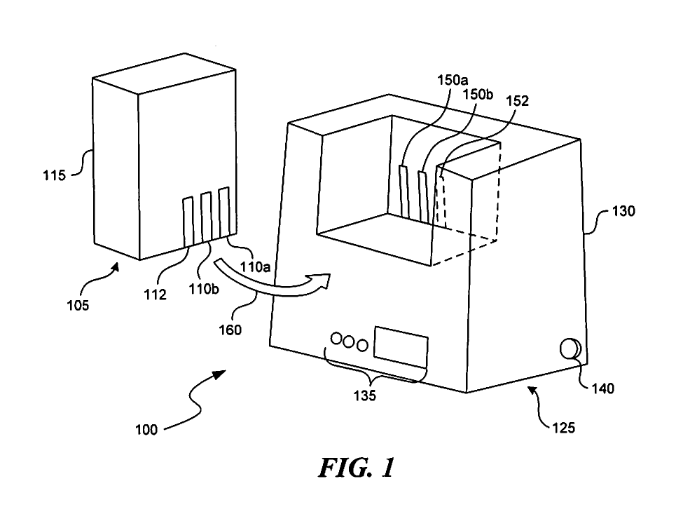

The present disclosure describes systems and methods for “patching” battery-interfacing host devices, such as battery chargers, and other electronic devices that interface with batteries or battery packs, such as computers, phones, medical devices, and global positioning system (GPS) devices. The “patches” can update, upgrade, enhance or otherwise change the performance characteristics and/or other attributes of the host devices. The battery pack can provide the vehicle by which the patches are delivered to the charger or other host device with which the battery pack interfaces. Certain details are set forth in the following description and in FIGS. 1-5 to provide a thorough understanding of various embodiments of the disclosure. Other details describing well-known aspects of battery packs and battery chargers however, are not set forth in the following disclosure so as to avoid unnecessarily obscuring the description of the various embodiments.

Many of the details, dimensions, angles and other features shown in the Figures are merely illustrative of particular embodiments. Accordingly, other embodiments can have other details, dimensions, angles and features. In addition, further embodiments can be practiced without several of the details described below.

In the Figures, identical reference numbers identify identical, or at least generally similar, elements. To facilitate the discussion of any particular element, the most significant digit or digits of any reference number generally refer to the Figure in which that element is first introduced. For example, element 100 is first introduced and discussed with reference to FIG. 1.

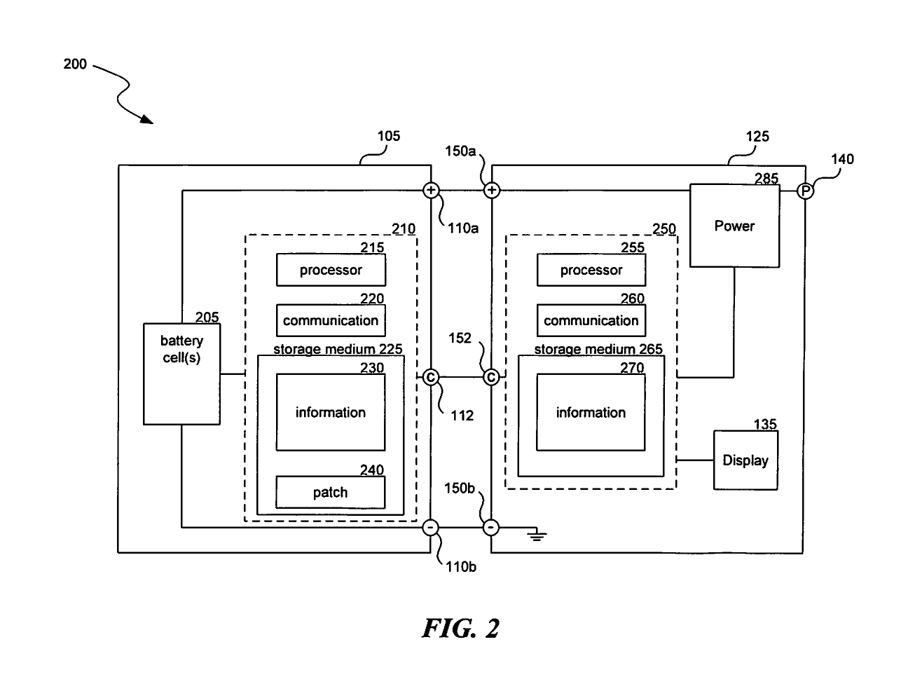

FIG. 1 is an isometric view of an overall system 100 that includes a battery package or battery pack 105 or other patch device, configured in accordance with a particular embodiment. The battery package 105 can include a casing, housing or shell 115. The battery package 105 includes at least one rechargeable cell (not shown in FIG. 1). The battery package 105 also includes a data contact or terminal 112 and power contacts or terminals 110, shown as a positive terminal 110a and a negative terminal 110b. Aspects of the terminals 110, 112 are described in more detail with reference to, for example, FIG. 2. The battery package 105 may implement at least some aspects of the Smart Battery Data Specification, Revision 1.1, Dec. 11, 1998, which is incorporated by reference herein.

The system 100 can also include a battery charger 125 or other host device. The battery charger 125 includes a casing, housing or shell 130 and a display 135 (for example, an LED display, or an LCD display) visually accessible from outside the exterior surface of the casing 130. The display 135 can present information, such as status information about the battery charger 125 or the battery pack 105. The battery charger 125 also includes a power connector 140 through which power (for example, alternating current) is supplied to the battery charger 125, for use in providing charging current to the cells of the battery pack 125 and/or for internal use by the battery charger 125. The battery package 105 also includes a data terminal 152 and power terminals 150, shown as a positive terminal 150a and a negative terminal 150b. Aspects of the terminals 150, 152 are also described in more detail with reference to, for example, FIG. 2. Although the battery charger 125 as illustrated includes only a single bay or port for charging a single battery package 125, the techniques described herein are applicable to multi-bay battery chargers capable of charging multiple battery packages 125. In any of these embodiments, each bay or port can include one or more suitable power terminals and one or more suitable data terminals that are configured to receive and connect to a removable battery pack. In still further embodiments, the techniques can be applied to host devices other than a battery charger, and/or patch devices other than a battery pack.

The battery charger 125 may implement at least some aspects of the Smart Battery Charger Specification, Revision 1.1, Dec. 11, 1998, and/or at least some aspects of the Smart Battery System Manager Specification, Revision 1.1, Dec. 15, 1998, each of which is incorporated by reference herein. The Smart Battery Data Specification, the Smart Battery Charger Specification, and the Smart Battery System Manager Specification are collectively referred to herein as the “Smart Battery Specifications.”

The battery package 105 is configured to be coupled to the battery charger 125, as indicated by arrow 160, such that the battery package terminals 110, 112 physically contact the corresponding battery charger terminals 150, 152 to create electrical connections between the battery package 105 and the battery charger 125. These connections allow both power and data to be transferred between the battery package 105 and the charger 125.

FIG. 2 is a block diagram illustrating components of the system 100 of FIG. 1, arranged in accordance with a particular embodiment. The battery package 105 includes one or more battery cells 205. The battery cells 205 can include a suitable chemistry, such as an alkaline, lithium, nickel cadmium, nickel metal-hydride, and/or lithium ion chemistry. The battery cells 205 are connected to the positive terminal 110a and the negative terminal 110b. The battery package 105 provides power to host devices through the positive and negative terminals 110a, 110b. The battery package 105 also includes a processor 215, a communication component 220, and a storage medium 225, all of which can be connected to each other and to other components of the battery package 105 by, for example, a System Management Bus (SMBus), an I²C bus, a DQ bus, an HDQ bus, a one-wire bus, and/or other types of signal paths, such as product-specific, non-standard or other suitable physical communication layers. The components enclosed by dashed lines 210 may be formed as an integrated circuit in the battery package 105.

The storage medium 225 can be any suitable medium that can be accessed by the processor 215 and can include both volatile and nonvolatile media, and removable and non-removable media. By way of example, and not limitation, the storage medium 225 may include volatile and nonvolatile, removable and non-removable media implemented via a variety of suitable methods or technologies for storage of information. Suitable storage media include, but are not limited to, RAM, ROM, EEPROM, flash memory or other memory technology, or any other suitable medium (for example, magnetic disks) which can be used to store the desired information and which can accessed by the processor 215.

The storage medium 225 stores information 230. The information 230 can include instructions, such as program modules, that are capable of being executed by the processor 215. Generally, program modules include routines, programs, objects, components, data structures, and so forth, which perform particular tasks or implement particular abstract data types. The information 230 can also include data, such as values stored in memory registers, which may be accessed or otherwise used by the processor 215. The battery package 105 may use the information 230 to perform various functions, such as measuring attributes, features, or characteristics of the battery cells 205, communicating with the battery charger 125, and/or other functions. Portions of the information 230 that are transmitted to the battery charger 125 are typically specific to the battery package 105. For example, such portions can include the charge state, the temperature, the serial number or the type of the battery pack 205.

In a particular embodiment, the storage medium 225 also stores one or more patches 240. A patch 240 is information, such as instructions or data, which is used to modify other information, such as information stored by the battery charger 125 (for example, battery charger firmware, software, and/or other information). The patch 240 may be permanent or temporary. For example, the patch 240 may be active for the life of the battery charger 125, or it may be partially or wholly superseded, for example, by another patch 240, and/or later wholly or partially backed out or otherwise removed. Patching refers to the process of applying a patch to the information to be modified. Patching can be useful to modify information for a variety of purposes, including correcting a programming error, reducing or eliminating a security risk, improving the logic used by the modified information, adding new features, and/or for other purposes. For example, a battery charger 125 may be patched to enable the battery charger 125 to charge more and/or different types of battery packages 105 than it had been previously capable of charging. In a particular example, the battery charger 125 may have instructions for charging cells with one type of chemistry, and the patch can include instructions for charging cells with another, different type of chemistry. As another example, a battery-interfacing device such as a portable defibrillator may initially support a certain number of languages (e.g., it can provide a user interface in such languages). The portable defibrillator may be patched to provide support for an additional language or to select a specific language. In still another example, the patch can change the rate at which a chest compression device applies compressions to a patient, based for example on new clinical data or medical discoveries. In general, the information transferred by the patch is retained and used by the battery charger 125 (or other host device) after the battery pack 105 (or other patch device) is removed. In any of the foregoing embodiments, the patch provided by the battery package 105 or other patch device can have applicability beyond just the patch device itself. For example, unlike battery package-specific information (e.g., such as battery package temperature or charge state), the patch can include information that is applicable to an entire class or type of battery packages (e.g., a new charging algorithm), or the operation of a host device in accordance with parameters that are independent of the particular battery package or even the type of battery package that powers the host device.

FIG. 2 also depicts components of the battery charger 125, which include a power component 285 that is connected to the power connector 140 and to the positive terminal 150a. The power component 285 may include a constant/variable voltage source and/or a constant/variable current source and/or other types of components for supplying power. The battery charger 125 charges the battery package 105 via the positive and negative terminals 150. The battery charger 125 also includes a processor 255, a communication component 260, and a storage medium 265, all of which can be coupled to each other and to other components of the battery charger 125 by, for example, one or more of the aforementioned types of signal paths and/or communication protocols. The components enclosed by dashed lines 250 may be formed as an integrated circuit.

Similar to the storage medium 225 of the battery package 105, the storage medium 265 of the battery charger 125 can be any of a variety of suitable media that can be accessed by the processor 255. The storage medium 265 includes information 270. The battery charger 125 may use the information 270 to perform various functions, such as regulating power provided to the battery package 105, communicating with the battery package 105, and/or other functions.

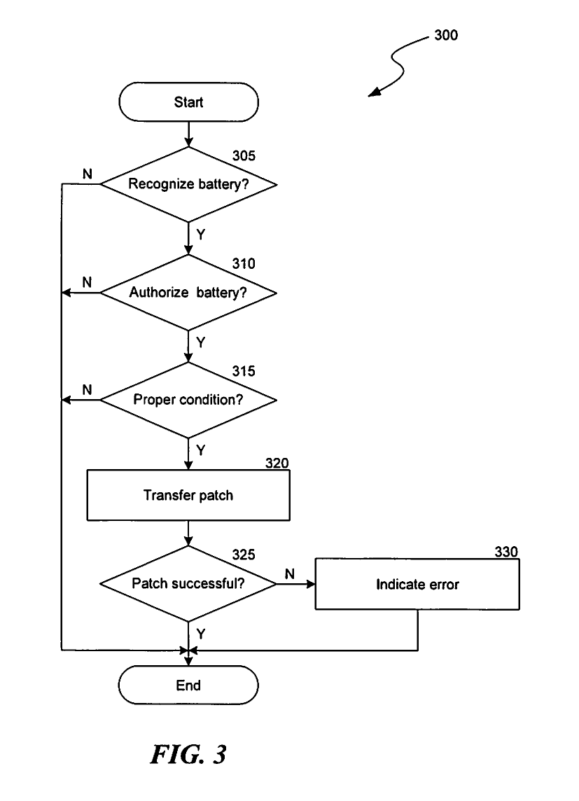

The battery package 105 and the battery charger 125 communicate through the data terminals 112, 152. For example, the battery charger 125 and the battery package 105 may communicate data, such as charging current values, charging voltage values, temperature values, and/or other information through the data terminals 112, 152. The battery charger 125 and the battery package 105 may communicate such data in accordance with the Smart Battery Specifications described above, or in accordance with other protocols. The data terminals 112, 152 may be necessary for the battery charger 125 to properly charge the battery package 105. As described in more detail, for example, with reference to FIG. 3, the battery package 105 also provides one or more patches 240 to the battery charger 125 through the data terminal 112 of the battery charger 125 and through the data terminal 152 of the battery charger 125.

In a particular embodiment, the process of patching is performed primarily by the battery charger 125, for example, when the battery charger 125 requests and obtains a patch 240 from the battery package 105. In other embodiments, the patching process may be performed wholly or partially by the battery package 105. For example, when the battery charger 125 is manufactured or initially formed, it may not be configured to request and obtain patches from a battery package 105 through the data terminal 152. Accordingly, the battery package 105 can perform these functions. However, the battery charger 125 may be retrofitted or otherwise reconfigured so as to enable the battery charger 125 to request and obtain patches through the data terminal 152. In some cases, the battery package 105 can provide this retrofit or upgrade (via the patch), either alone or in combination with another update. Accordingly, the battery pack 105 can perform an initial patch function that includes installing in the charger 125 the ability to perform subsequent patch functions with passive patch devices. As another example, the battery charger 125 may be manufactured at the outset with the capability to receive update patches, such that the battery charger 125 is configured to request and obtain patches from a battery package 105 through the data terminal 152 at the outset. Accordingly, the patching process may be performed by the battery charger 125 as it requests and obtains patches from a battery package 105 through the data terminal 152.

FIG. 3 is a flow diagram of a process 300 for patching a battery charger 125 in accordance with an embodiment of the disclosure. Certain elements discussed below with reference to FIG. 3 are shown in FIG. 2. In block 305, the battery charger 125 determines whether it recognizes the battery package 105. For example, the battery charger 125 may call the Smart Battery Specification function SerialNumber( )to obtain an identifier of the battery package 105 that is stored in the battery package storage medium 225 (FIG. 2). Additionally or alternatively, the battery charger 125 may use other techniques to obtain the identifier, such as calling another function that returns an identifier, or reading an identifier from one or more locations in the storage medium 225. The identifier may be generally unique (meaning that it uniquely identifies the battery package 105 amongst multiple battery packages, e.g., via a serial number or other suitable identifier). The battery charger 125 may then compare the identifier to one or more identifiers stored in the battery charger storage medium 265, or otherwise analyze the identifier. If the battery charger 125 does not recognize the identifier, the process 300 ends. If the battery charger 125 recognizes the identifier, the process 300 continues to block 310. Additionally or alternatively, the battery charger 125 may use other techniques to determine whether it recognizes the battery package 105. For example, the battery charger 125 may obtain a name of a manufacturer of the battery package 105 and analyze the name to determine whether it recognizes the battery package 105.

At block 310, the battery charger 125 authorizes the battery package 105. For example, the battery charger 125 may use authorization techniques based on the SHA-1 algorithm (which is well-known to those of ordinary skill in the relevant art) to authorize the battery package 105. In such an example, the battery charger 125 and the battery package 105 can both store an authorization key. The battery charger 125 can send a challenge to the battery package 105. The battery package 105 can then compute a response to the challenge using the authorization key and write it to the storage medium 225 for retrieval by the battery charger 125. The battery charger 125 can read the response from the storage medium 225 and compare it to an anticipated response that the battery charger 125 computed using the authorization key and the challenge. If the battery charger 125 determines that the two responses match, then the battery charger 125 authorizes the battery package 105, and the process 300 continues to block 315. If the two responses do not match, then the battery charger 125 rejects the battery package 105 and the process 300 concludes. Additionally or alternatively, the battery charger 125 may use other techniques to authorize the battery package 105.

At block 315, the battery charger 125 determines whether proper conditions for patching the battery charger 315 exist. For example, the battery charger 125 may be precluded from being patched by one or more existing conditions, such as if the battery charger 125 is currently charging other battery packages 105, and/or the battery charger 125 has already been patched, and/or other conditions that prevent the battery charger 125 from being patched. If the proper conditions do not exist, the process 300 concludes. Otherwise, the process 300 continues to block 320.

At block 320, the battery charger 125 transfers the patch 240 from the battery package 105 to the battery charger 125. In a particular embodiment, the battery charger 125 does so by reading the patch 240 from the storage medium 225 of the battery package 105 and writing it to the storage medium 265 of the battery charger 125. The battery charger 125 then applies the patch 240, such as by executing the patch 240, to modify the information 270 stored in the storage medium 265. In some embodiments, the battery charger 125 may apply the patch 240 to modify the information 270 without executing the patch 240. The process 300 then continues to block 325.

At block 325, the battery charger 125 determines whether the patching process was successful. The battery charger 125 may make this determination in various ways, such as by evaluating criteria included in the patch 240, by verifying data stored in various portions of the storage medium 265, and/or in other ways. If the patching is not successful, the process 300 continues at block 330, in which the battery charger 125 indicates an error, such as by displaying a red light using the display 135. The battery charger 125 may indicate the error for various reasons, such as to inform a person that the battery charger 125 should not be used to charge battery packages 105. After block 330, the process 300 concludes. If the patching is successful, the process 300 also concludes.

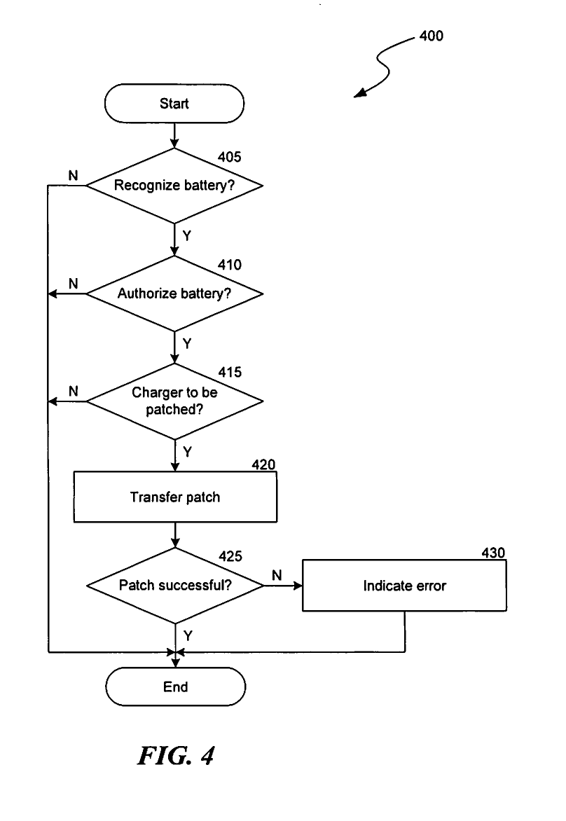

FIG. 4 is a flow diagram of a process 400 for patching a battery charger 125 in accordance with another embodiment of the disclosure. The process 400 may be performed by a battery package 105 to modify a battery charger 125, such as a battery charger 125 that is not specifically configured to obtain patches from a battery package 105 through the data terminal 152. Blocks 405 and 410 are generally similar to blocks 305 and 310, respectively, of the process 300, and accordingly, blocks 405 and 410 are not further described herein. In other embodiments, blocks 405 and 410 can be eliminated, e.g., when it is desirable to provide a patch to the battery charger 125 without authorizing the battery.

At block 415 the battery package 105 determines whether the battery charger 125 is to be patched. The battery package 105 may make this determination in various ways, such as by determining if the battery charger 125 has been previously patched. If the battery package 105 determines that the battery charger 125 is not to be patched, the process 400 ends. If the battery package 105 determines that the battery charger 125 is to be patched, the process 400 continues to block 420.

At block 420, the battery package 105 transfers the patch 240 to the battery charger 125. The battery package 105 may use various techniques to transfer the patch. For example, the battery charger 125 may call a certain function and expect that the battery package 105 respond to the function call by providing a certain amount of data. However the battery package 105 may provide more than the expected amount of data to the battery charger 125, and thereby cause the battery charger 125 to copy excess data to particular locations in the storage medium 265, and execute the excess data. The excess data may be instructions that, when executed by the battery charger 125, cause the battery charger 125 to modify information stored in the storage medium 265. This technique may be similar to buffer overrun exploits and/or other techniques that exploit security flaws and/or loopholes of the battery charger 125. As another example, the battery charger 125 may read information from certain portions of the storage medium 225 and copy it to certain portions of the storage medium 265. The processor 255 or other component may then execute the copied information in the storage medium 265, thereby causing the patch 240 to be applied to the battery charger 125. The battery package 105 may also employ other techniques used by computer viruses to cause computing devices to execute code to cause the patch 240 to be applied and thereby modify information stored in the storage medium 265. The battery package 105 may also use a boot loader of the battery charger 125 to transfer the patch and cause the patch 240 to be applied. The process 400 then continues to block 425. Blocks 425 and 430 are generally similar to blocks 325 and 330, respectively, of the process 300, and accordingly, blocks 425 and 430 are not further described herein. Blocks 425 and 430 can be performed by the charger 125 in some embodiments, and by the battery package 105 in other embodiments. After block 425 or block 430 the process 400 concludes.

In some embodiments, after being patched by a battery package 105, the battery charger 125 can transfer the patch 240 to other battery packages 105, such that the other battery packages 105 can subsequently patch other battery chargers 125. Accordingly, the technique can be used to spread the patch from one battery charger (or other host device) to another.

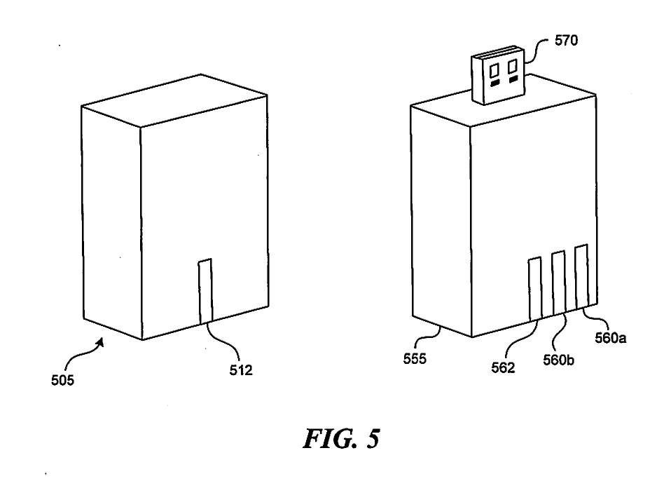

FIG. 5 is an isometric view of two different patch devices configured in accordance with embodiments of the disclosure. Each of the two different patch devices may be used to interface with battery chargers and/or other electronic devices. A first patch device includes a simulated battery 505. The simulated battery 505 may include some or all of the components as the battery package 105 (for example, the processor 215, the communication component 220 and the storage medium 225). However, the simulated battery 505 may not include cells that are used to provide power to an external electronic device. Instead, the simulated battery 505 may include cells or other power sources that only power components internal to the simulated battery 505. In other embodiments, the simulated battery 505 may include no cells or other power sources. The simulated battery 505 includes a data terminal 512 configured to contact a corresponding data terminal of a battery charger or other electronic device.

FIG. 5 also illustrates a second patch device 555 that includes a Universal Serial Bus (USB) connector 570. The second patch device 555 may include some or all of the components of the battery package 105 (for example, the processor 215, the communication component 220 and the storage medium 225), but may not include cells that provide power to the device 555. Instead, the device 555 may receive power from a battery charger through terminals 560. The device 555 also includes a data terminal 562 configured to contact a corresponding data terminal of a battery charger or other host device. The patch device 555 may receive patches through the USB connector 570, such as from a computing device to which the device 555 may be connected. The patch device can then transmit the patches to the host device via the data terminal 562.

The patch devices 505, 555 can be used to provide patches to battery chargers through the data terminals 512, 562. Other types of devices (for example, battery eliminators) may also be used to provide patches to battery chargers, as long as the other types of devices include the appropriate data terminals for interfacing with the battery chargers. Such devices can include a power transmitter (e.g. an AC/DC or DC/DC transformer) that converts power from once source to power suitable for the host device, without necessarily also including a battery cell.

The battery pack 105 and/or the other patch devices 505, 555 can provide patches to a wide variety of electronic devices that interface with batteries and that are capable of being patched. These electronic devices include, but are not limited to: personal computing devices (for example, laptop computers, netbook computers, etc.), field instruments (for example, chemical and gas detectors, telecom test equipment, wireless test equipment, power measurement devices, etc.), handheld or man-portable military devices (for example, wireless LAN transceivers, head-mounted displays, radios, satellite phones, GPS receivers, daylight video scopes, thermal weapon scopes, wearable computers, etc.), data collection devices (for example, bar code scanners, handheld readers, portable printers, PDAs, other handheld computers, etc.), medical devices (for example, defibrillators, ultrasounds, monitors, pumps, ventilators, etc.), other electronic devices (for example, cordless telephones, cellular telephones, smartphones, lighting devices), battery chargers, and other electronic devices that interface with batteries and that are capable of being patched.

One advantage of at least some of the techniques and devices described herein is that they enable patching a battery charger using the data terminals of the battery pack and battery charger. This use of the data terminals obviates the need to use a separate data port or data interface (for example, a serial port) to patch a battery charger. Battery chargers configured in accordance with this disclosure can therefore be manufactured without a separate data port. This reduces the risk of damage to the battery charger by eliminating a separate avenue for ingress of contaminants that have the potential to damage sensitive electrical components of the battery charger.

Another advantage of at least some of the techniques and devices described herein is that they obviate the need for (a) a technician to make a service visit to a location of the battery charger and/or (b) the battery charger to be recalled or otherwise transferred to a service center. Instead, a user, such as a user at a location remote from a technician or a service center, can patch the battery charger simply by coupling a battery package that includes a patch to the battery charger. This simplifies and facilitates the patching process and can be performed by any person capable of coupling a battery package to a battery charger. Accordingly, the techniques described herein enable a battery charger to be patched more readily and more easily than existing techniques. This advantage can apply as well to other host devices and other patch devices.

From the foregoing, it will be appreciated that specific, representative embodiments have been described herein for purposes of illustration, but that various modifications may be made to these embodiments. For example, the battery packages 105 can have features other than those described above and shown in the Figures and may also include more or fewer components than those illustrated. For example, in some embodiments the battery packages 125 include AC/DC converters and/or DC/DC converters and/or additional electrical and/or electronic components. In some embodiments a different number of battery cells may be housed in variously sized packages, and in other embodiments the battery cells may comprise non-rechargeable chemistries. In some embodiments, the battery cells may be at least partially covered with shrink wrap or other material to join the battery cells together. In some embodiments, in addition to or as an alternative to battery cells 205, the battery package 105 may include other types of energy storage devices, such as fuel cells, capacitors (for example, supercapacitors), or hybrid arrangements of one or more of these energy storage devices. In some embodiments, the battery pack includes a single energy storage device and an electrical component, such as a printed circuit board. The battery package can be coupled to any of a wide variety of portable and stationary electronic devices. While certain details of the current technology were described in the context of a patch for a battery charger, generally similar devices and methodologies can be used to patch host devices (e.g., equipment and/or systems) other than battery chargers, that also interface with batteries. Additional embodiments are within the scope of the present disclosure.

Certain aspects of the technology described in the context of particular embodiments may be combined or eliminated in other embodiments. For example, the USB port shown in FIG. 5 can be used incorporated into the battery pack 105 shown in FIG. 1. Methods of manufacturing and/or forming battery packages and/or battery chargers in accordance with embodiments described herein are within the scope of the present disclosure. Further, while advantages associated with certain embodiments have been described in the context of those embodiments, other embodiments may also exhibit such advantages, and not all embodiments need necessarily exhibit such advantages to fall within the scope of the present disclosure.

I/we claim:

1. A battery system, comprising:
a battery charger, including:
a first power terminal through which the battery charger transmits electrical current;
a first data terminal through which the battery charger receives, transmits, or both receives and transmits data; and
a first storage medium coupled to the first data terminal; and
a battery pack, including:
a battery cell;
a second power terminal coupled to the battery cell and releasably coupleable to the first power terminal to receive current from the charger;
a second storage medium having a patch, the patch including information that is not specific to only the battery pack; and
a second data terminal coupled to the second storage medium and coupleable to the first data terminal of the battery charger, the patch being communicable to the battery charger via the first and second data terminals.

2. The battery system of claim 1 wherein the battery charger further includes a processor and wherein the patch modifies instructions executed by the processor.

3. The battery system of claim 1 wherein the charger includes firmware and wherein the patch modifies instructions executed by the firmware.

4. The battery system of claim 1 wherein the battery cell has a first chemistry, and wherein the patch includes a charging algorithm for charging a battery cell having a second chemistry different than the first chemistry.

5. A system, comprising:
a host device that includes:
a power terminal positioned to releasably couple to a corresponding power terminal of a battery pack; and
a first data terminal positioned to releasably couple to corresponding data terminal of the battery pack; and
a patch device that includes:
a second data terminal coupleable to the first data terminal of the host device; and
a storage medium having a having a patch that is communicable to the host device via the first and second data terminals, the patch including information that is not specific to just the patch device.

6. The system of claim 5 wherein the host device includes a battery charger.

7. The system of claim 5 wherein the host device includes a medical device.

8. The system of claim 5 wherein the patch device includes a battery cell.

9. The system of claim 5, further comprising the battery pack, and wherein:
the host device is a battery charger;
the battery pack is a first battery pack having a first chemistry;
the patch device forms a portion of a second battery pack having the first chemistry;
the patch device includes at least a portion of an algorithm for charging a battery pack having a second chemistry different than the first chemistry.

10. A battery pack, comprising:
a battery cell;
a power terminal coupled to the battery cell and coupleable to a corresponding power terminal of a host device;
a storage medium having a patch, the patch including information that is not specific to only the battery pack; and
a data terminal coupled to the storage medium and coupleable to a corresponding data terminal of the host device, the patch being transmissible away from the storage medium via the data terminal.

11. The battery pack of claim 10 wherein the patch includes machine-readable instructions to be executed by the host device.

12. The battery pack of claim 11 wherein the instructions include instructions that, when executed by the host device, control a process by which the host device recharges battery cells.

13. A patch device, comprising:
a storage medium having a patch, the patch including information that is not specific to only the patch device; and
a data terminal coupled to the storage medium and coupleable to a corresponding data terminal of a battery port of a host device, the patch being transmissible away from the storage medium via the data terminal.

14. The patch device of claim 13, further comprising:
a battery cell; and
a power terminal coupled to the battery cell and coupleable to a corresponding power terminal of the battery port of the host device simultaneously with the data terminal coupling to the corresponding data terminal of the host device.

15. The patch device of claim 13, further comprising a power transmitter releasably coupleable between the host device and a power source.

16. The patch device of claim 13 wherein the patch includes instructions for changing a manner in which the host device accepts subsequent patches.

17. A method of updating a battery-powered host device, comprising:
powering the host device by connecting a first battery pack to the host device, wherein connecting the first battery pack includes connecting a power terminal of the first battery pack to a corresponding power terminal of the host device, and connecting a data terminal of the first battery pack to a corresponding data terminal of the host device;
conveying information to the host device via the data terminal of the first battery pack that is specific to the first battery pack;
removing the first battery pack from the host device;
connecting a second battery pack to the host device, wherein connecting the second battery pack includes connecting a power terminal of the second battery pack to the corresponding power terminal of the host device, and connecting a data terminal of the second battery pack to the corresponding data terminal of the host device; and
transmitting a patch from a storage medium of the second battery pack to the host device via the data terminal of the second battery pack and the data terminal of the host device, wherein the patch includes information that is not specific to just the second battery pack and further includes an algorithm or a change for an algorithm executed by the host device.

18. The method of claim 17 wherein the host device is a first host device and wherein the method further comprises:
transmitting the patch from the first host device to a third battery pack different than the second battery pack; and
transmitting the patch from the third battery pack to a second host device different than the first host device.

19. A method for updating a battery-powered host device, comprising:
powering the host device by connecting a battery pack to the host device, wherein connecting the battery pack includes connecting a power terminal of the battery pack to a corresponding power terminal of the host device, and connecting a data terminal of the battery pack to a corresponding data terminal of the host device;
conveying information to the host device via the data terminal of the battery pack that is specific to just the battery pack;
removing the battery pack from the host device;
connecting a patch device to the host device, wherein connecting the patch device includes connecting a data terminal of the patch device to the corresponding data terminal of the host device; and
transmitting a patch from a storage medium of the patch device to the host device via the data terminal of the patch device and the data terminal of the host device, wherein the patch includes information that is not specific to just the patch device.

20. The method of claim 19, further comprising automatically verifying that the operation of transmitting the patch was completed.

21. The method of claim 19, further comprising authorizing the patch device prior to transmitting the patch.

22. The method of claim 19 wherein transmitting the patch is performed independent of whether the patch device is authorized or not.

23. The method of claim 19 wherein the host device is a first host device and the patch device is a first patch device and wherein the method further comprises:
transmitting the patch from the first host device to a second patch device different than the first patch device; and
transmitting the patch from the second patch device to a second host device different than the first host device.

24. A method of manufacture, comprising:
storing a patch on a storage medium of a patch device, the patch including information that is not specific to just the patch device;
connecting the storage medium to a data terminal of the patch device that is releasably engagable with a corresponding data terminal of a host device, wherein the corresponding data terminal is also releasably engagable with a battery pack data terminal carried by a battery pack that provides power to the host device.

25. The method of claim 24 wherein providing the storage medium with a patch includes providing the storage medium with the patch via the first data terminal after connecting the storage medium to the first data terminal.
